(19) United States
(12) Patent Application Publication
(10) Pub. No.: US 2005/0146991 A1
(43) Pub. Date: Jul. 7, 2005

(54) Method and device for data dependent field switching for domain expansion reading and record carrier for use by the method

(76) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/504,135

(22) PCT Filed: Jan. 24, 2003
(86) PCT No.: PCT/IB03/00202

(30) Foreign Application Priority Data
Feb. 14, 2002 (EP) 02075598.9

(51) Int. Cl. G11B 11/00

(52) U.S. Cl. 369/13.02; 369/59.14

(57) ABSTRACT

The present invention relates to a method and an apparatus for reading a domain expansion magneto-optical recording medium. A switching time of an external magnetic field is derived from a reading pulse obtained and the switching period of the external magnetic field is set to a value larger than the channel bit length of a storage layer. Higher data rates are thus allowed due to the fact that the bandwidth requirements of the coils and driver circuits are lowered.

The present invention relates to a method, apparatus and record carrier for reading a domain expansion recording medium, such as a MAMMOS (Magnetic AMplifying Magneto-Optical System) disk, comprising a recording or storage layer and an expansion or read-out layer.

In magneto-optical storage systems the minimum width of the recorded marks is determined by the diffraction limit, that is by the Numerical Aperture (NA) of the focussing lens and the laser wavelength. A reduction of the width is generally based on shorter wavelength lasers and higher NA focussing optics. During magneto-optical recording, the minimum bit length can be reduced to below the optical diffraction limit by using Laser Pulsed Magnetic Field Modulation (LP-MFM. In LP-MFM, the bit transitions are determined by the switching of the field and the temperature gradient induced by the switching of the laser. For read-out of the small crescent-shaped marks recorded in this way, Magnetic Super Resolution (MSR) or Domain Expansion (DomEx) methods have been proposed. These technologies are based on recording media with several magneto-static or exchange-coupled RE-TM layers. According to MSR, a read-out layer on a magneto-optical disk is arranged to mask adjacent bits during reading, while, according to domain expansion, a domain in the center of a spot is expanded. The advantage of the domain expansion technique over MSR results in that bits with a length below the diffraction limit can be detected with a similar signal-to-noise ratio (SNR) as bits with a size comparable to the diffraction limited spot. MAMMOS is a domain expansion method based on magneto-statically coupled storage and read-out layers, wherein a magnetic field modulation is used for expansion and collapse of expanded domains in the read-out layer.

In the above-mentioned domain expansion techniques, like MAMMOS, a written mark from the storage layer is copied to the read-out layer upon laser heating with the aid of an external magnetic field. Due to the low coercivity of this read-out layer, the copied mark will expand to fill the optical spot and can be detected with a saturated signal level which is independent of the mark size. Reversal of the external magnetic field collapses the expanded domain. A space in the storage layer, on the other hand, will not be copied and no expansion occurs. Therefore, no signal will be detected in this case.

The laser power used in the read-out process should be high enough to enable copying. On the other hand, a higher laser power also increases the overlap of the temperature-induced coercivity profile and the stray field profile of the bit pattern. The coercivity H_{c} decreases and the stray field increases with increasing temperature. When this overlap becomes too large, correct read-out of a space is no longer possible due to false signals generated by neighboring marks. The difference between this maximum and the minimum laser power determines the power margin, which decreases strongly with decreasing bit length. Experiments have shown that with the current methods, bit lengths of 0.10 μm can be correctly detected, but at a power margin of virtually nothing (1 bit of a 16 bit DAC). Thus, for highest densities the power margin remains quite small so that optical power control during read-out is essential.

In conventional MAMMOS read-out, the external magnetic field is modulated with a period corresponding to the size of a channel bit. Thus, a bit decision is made for each channel bit (mark or space, i.e. up or down magnetization). However, synchronization of the external field modulation with the bit pattern on the disc is critical. For example, when the copy window is close to its maximum size for correct read-out, a small phase error already introduces a false peak. For this synchronization, timing fields and/or a wobble in the track can be used. In this way, quite reasonable frequency control is possible, but phase errors are very difficult to avoid.

In addition, a field period equal to the size of a channel bit requires very fast coil and driver electronics (two times faster than for recording) for high density, high data rate applications. In other words, the limited bandwidth of the coil and driver system (at present ≅200 MHz) may limit the attainable data rate (e.g. to about 100 Mb/s).

It is an object of the present invention to provide a reading method and apparatus and a record carrier for domain expansion read-out which allow higher read-out data rates.

This object is achieved by a method as claimed in claim 1, by an apparatus as claimed in claim 8, and by a record carrier as claimed in claim 14.

Accordingly, higher data rates are allowed due to the fact that the bandwidth requirements of the coils and driver circuits for generating the external magnetic field are lowered. The large field period results in an asynchronous read-out of longer mark run-lengths. However, if the size of the copy window is known, correct detection is possible.

Preferably, the switching period is set to a value equal to the sum of the maximum allowed copy window and the channel bit length, e.g. to a value three times the channel bit length if the maximum allowed copy window size is twice the channel bit length.

A space run-length may be determined by measuring a time delay during which the external magnetic field stays in the expansion direction. Due to the fact that this delay time has no fixed period, space increments smaller than the channel bit length can be used to significantly improve the resolution.

According to an advantageous further development, the read-out information can be obtained only from space run-lengths. Although this reduces the storage efficiency, because marks no longer contain information, the demands on the copy window control are significantly lowered. This can compensate for the reduction of storage efficiency.

The setting means of the reading apparatus may be arranged to set the switching period to a value equal to the sum of the maximum allowed copy window and said channel bit length.

Furthermore, determination means may be provided in the reading apparatus, for determining a space run-length by measuring a time delay during which said external magnetic field stays in the expansion direction. In particular, the determination means may comprise a timer means for counting the time delay.

Other advantageous further developments are defined in the dependent claims.

The present invention will be described hereinafter on the basis of a preferred embodiment and with reference to the accompanying drawings, in which:

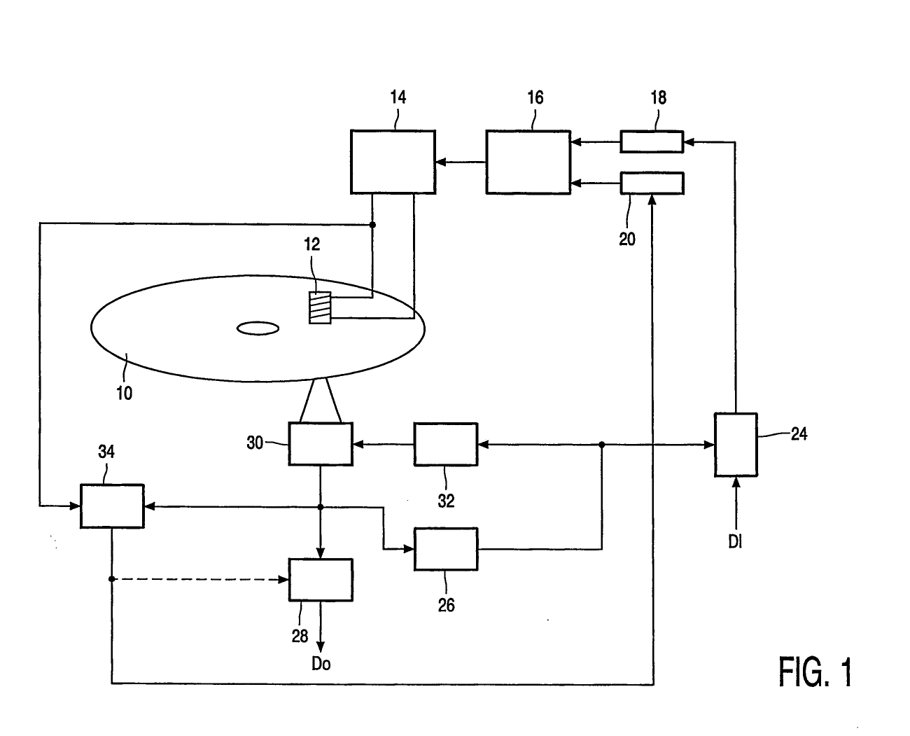

FIG. 1 shows a diagram of a magneto-optical disk player according to an referred embodiment,

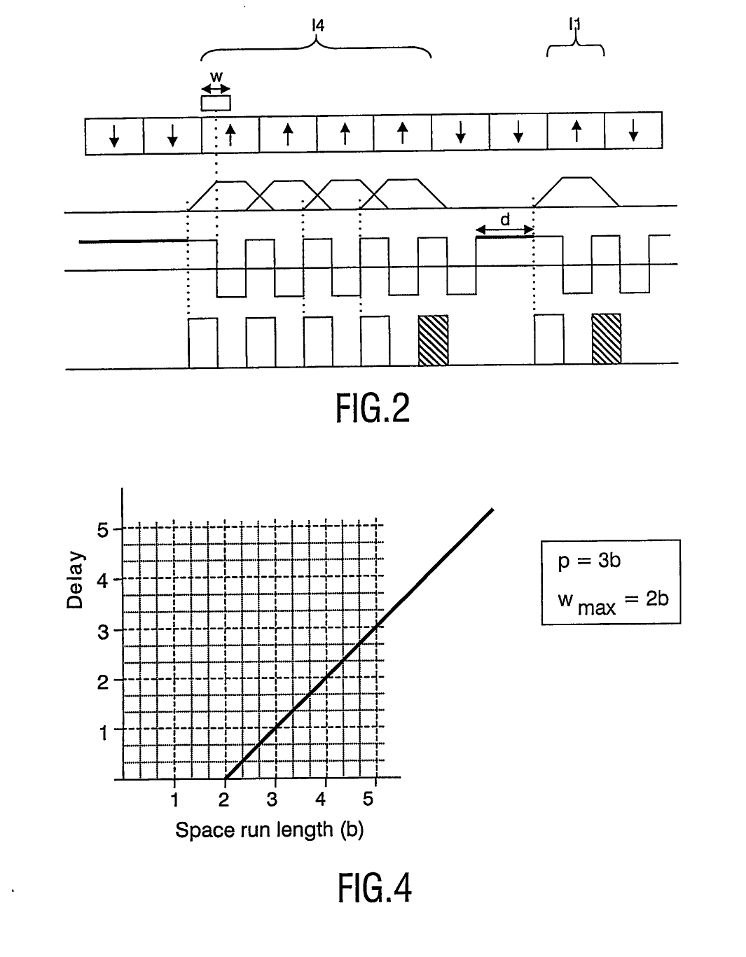

FIG. 2 shows read-out waveforms for a read-out operation with a fixed field period corresponding to one channel bit length,

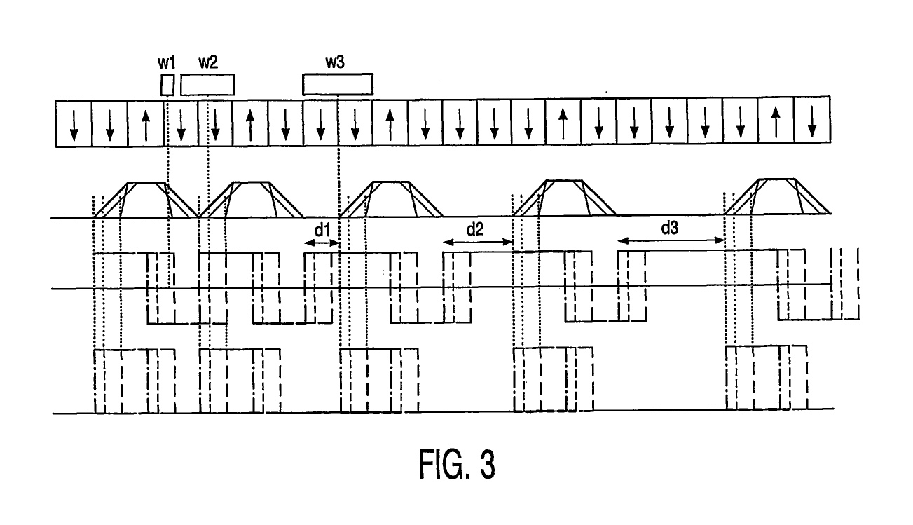

FIG. 3 shows read-out waveforms for read-out operations with various window sizes and a fixed field period corresponding to three channel bit lengths, and

FIG. 4 shows a diagram indicating a characteristic of a MAMMOS peak delay as a function of the space run-length.

A preferred embodiment will now be described on the basis of a MAMMOS disk player as indicated in FIG. 1. FIG. 1 schematically shows the construction of the disk player according to preferred embodiments. The disk player comprises an optical pick-up unit 30 having a laser light radiating section for irradiation of a magneto-optical recording medium or record carrier 10, such as a magneto-optical disk, with light that has been converted, during recording, to pulses with a period synchronized with code data and a magnetic field applying section comprising a magnetic head 12 which applies a magnetic field in a controlled manner at the time of recording and playback on the magneto-optical disk 10. In the optical pick-up unit 30 a laser is connected to a laser driving circuit which receives recording and read-out pulses from a recording/read-out pulse adjusting unit 32 to thereby control the pulse amplitude and timing of the laser of the optical pick-up unit 30 during a recording and read-out operation. The recording/read-out pulse adjusting circuit 32 receives a clock signal from a clock generator 26 which may comprise a PLL (Phase Locked Loop) circuit.

It is to be noted that, for reasons of simplicity, the magnetic head 12 and the optical pick-up unit 30 are shown on opposite sides of the disk 10 in FIG. 1. However, according to the preferred embodiment, they should be arranged on the same side of the disk 10.

The magnetic head 12 is connected to a head driver unit 14 and receives, at the time of recording, code-converted data via a phase adjusting circuit 18 from a modulator 24. The modulator 24 converts input recording data to a prescribed code.

At the time of playback, the head driver 14 receives a timing signal via a playback adjusting circuit 20, from a timing circuit 34, the playback adjusting circuit 20 generating a synchronization signal for adjusting the timing and amplitude of pulses applied to the magnetic head 12. The timing circuit 34 derives its timing signal from the data read-out operation as described later. Thus, data-dependent field switching can be achieved. A recording/playback switch 16 is provided for switching or selecting the respective signal to be applied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to decode the reading signal to generate output data. Furthermore, the reading signal generated by the optical pick-up unit 30 is applied to a clock generator 26 in which a clock signal obtained from embossed clock marks of the disk 10 is extracted, and which applies the clock signal for synchronization purposes to the recording pulse adjusting circuit 32 and the modulator 24. In particular, a data channel clock may be generated in the PLL circuit of the clock generator 26. It is to be noted that the clock signal obtained from the clock generator 26 may as well be applied to the playback adjusting circuit 20 to thereby provide a reference or fallback synchronization which may support the data dependent switching or synchronization controlled by the timing circuit 34.

In the case of data recording, the laser of the optical pick-up unit 30 is modulated with a fixed frequency, corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The recording data are modulated and code-converted by the modulator 24 to obtain binary run-length information corresponding to the information of the recording data.

The structure of the magneto-optical recording medium 10 may correspond to the structure described in the JP-A-2000-260079.

In the preferred embodiment shown in FIG. 1, the timing circuit 34 is provided for applying a data-dependent timing signal to the playback adjusting circuit 20. As an alternative, the data-dependent switching of the external magnetic field may as well be achieved by applying the timing signal to the head driver 14, so as to adjust the timing or phase of the external magnetic field.

According to the preferred embodiment, timing information is obtained from the (user) data on the disc 10. To achieve this, the playback adjusting circuit 20 or the head driver 14 is adapted to provide an external magnetic field which extends normally in the expansion direction. When a rising signal edge of a MAMMOS peak is observed by the timing circuit 34 at an input line connected to the output of the optical pick-up unit 30, the timing signal is applied to the playback adjusting circuit 20 such that the head driver 14 is controlled to reverse the magnetic field after a short time so as to collapse the expanded domain in the read-out layer, and shortly after that reset the magnetic field to the expansion direction. The total time between the peak detection and the field reset is set by the timing circuit 34 to correspond to the sum of the maximum allowed copy window and one channel bit length on the disk 10 (times the linear disc velocity).

With the data-dependent field switching method mentioned above, synchronization is no longer required during read-out, as the switching time is derived directly from the data.

The derived switching times can be used to further advantage as input for the PLL circuit of the clock generator 26 to provide accurate data clock for (more) precise data recovery e.g. based on space run-length information as explained later.

FIGS. 2 and 3 show diagrams indicating (from top to bottom) a storage layer with its mark and space regions (indicated by upward and downward arrows, respectively) and with a copy window size w indicating the spatial width of the copy operation, and waveforms of an overlap signal, the alternating external magnetic field and the MAMMOS read-out signal. The overlap signal indicates a time-dependent value of the overlap between the coercivity profile and the stray field, which leads to a MAMMOS signal or peak when an external magnetic field is applied. In particular, a MAMMOS peak will be generated during the time period of the positive external magnetic field. Due to the fact that the overlap signal may extend until a neighboring (previous or next) positive period of the external magnetic field, additional peaks can be generated in the MAMMOS signal.

FIG. 2 shows a storage layer with a data pattern comprising an 14 mark run-length (corresponding to four channel bit lengths) and an I1 mark run-length (corresponding to one channel bit length). For a copy window size w larger than zero, e.g. equal to half the channel bit length b (as shown in FIG. 2), each mark run-length (indicated by upward arrows) will give at least one more MAMMOS peak (hatched) than its length divided by the channel bit length b which corresponds to one section in the schematically shown storage layer. Thus, an I1 mark run-length (length b) will give two peaks instead of one, an I2 mark run-length (length 2b) will give three peaks instead of two, etc.

According to the preferred embodiment, these additional peaks can be avoided by selecting a larger field period p (i.e. period of the external magnetic field) equal to the sum of the maximum allowed copy window w (this value will be chosen in dependence on the allowed power margin) and the length b of a mark (channel bit), as expressed in the following equation:
p=wₘₐₓ+b (1)
This larger period is beneficial for high data rates, where the bandwidth of the coil of the magnetic head 12 is a limiting factor.

The space run-lengths can be derived from the time (or delay) that the magnetic field stays in the expansion direction (positive values) before the next MAMMOS peak appears. These times d, d1, d2, d3 are indicated in the FIGS. 2 and 3. When a rising signal edge of the magnetic field is observed by the timing circuit 34, e.g. on the basis of the output signal of the head driver 14, a timer circuit or timer function provided in the timing circuit 34 is started so as to count the time until a rising signal edge of the next MAMMOS peak is detected at the output of the optical pick-up circuit 30.

It will be clear that a space run-length equal to the channel bit length b has no delay, so that it cannot be detected. In FIG. 2, a delay d corresponding to an −I2 space run-length. (length 2b, “−” indicates a space) is indicated.

FIG. 3 illustrates this read-out scheme for different values of the copy window size w1, w2 and w3, at a fixed period p=3b and wₘₐₓw3=2b (dotted lines). It is to be noted that the value of wₘₐₓ directly determines the minimum space length that can be detected correctly. Thus, a larger maximum window which allows an easier power control will lead to a higher d constraint for the space run-length and, therefore, lower densities.

A larger field period implies that read-out of a mark run-length (with increments of b) larger than b will be asynchronous; this can lead to a number of peaks that differs from the run-length divided by b.

In FIG. 3, delays d1, d2 and d3, corresponding to a −I3, −I4 and −I5 space run-length, respectively, are indicated for the copy window size w3. However, as can be seen in this figure, the delays are identical for the different sizes w1, w2 and w3. The dash-dotted, solid and dotted waveforms, which correspond to the window sizes w1, w2 and w3, respectively, of the external magnetic field and the MAMMOS peaks only differ in the switching timing or phase.

FIG. 4 shows a diagram indicating a characteristic curve of the peak delay d as a function of the space run-length SRL. From the FIGS. 3 and 4 it can be gathered that the delay determined at the timing circuit 34 is a smooth function of the space run-length. Therefore, there is no reason to increment space run-lengths by b (indicated by dashed grid lines in FIG. 4) as in the case of mark run-lengths. If the jitter in the read-out signal is small enough, increments (much) smaller than b (dotted grid lines in FIG. 4) can be used, thus significantly increasing the storage density. Due to the maximum copy window size w3=2b, a minimum space run-length larger than two channel bit lengths b is required. The delay d determined can be applied from the timing circuit 34 to the decoder 28 such that a correct or precise decoding function for the space run-lengths can be achieved.

When the copy window size w is known and remains sufficiently constant, the data pattern can be reconstructed from the observed peaks.

Asynchronous read-out of mark run-lengths can be avoided by only using marks with a constant length which may correspond to one channel bit length b. Then, information is only stored in the space run-lengths separated by marks (Non Return to Zero (NRZ)). Obviously, this will reduce the storage density, but the demands on the copy window control are significantly lowered. A corresponding data pattern is shown in the storage layer of FIG. 3.

As already mentioned, space run-lengths in this scheme can be derived from the time (or delay) that the magnetic field extends in the expansion direction before the next MAMMOS peak appears. These times are indicated in FIG. 3 by d1 to d3. Due to the fact that this delay time has no fixed period, space increments smaller than the channel bit length can be used to thereby significantly improve the resolution.

Thus, the proposed reading scheme with the field period larger than the channel bit length allows high data rate read-out at relatively high densities. Depending on the accuracy of the power control, either the mark run-length determination based on a correction of asynchronous read-out can be used for higher densities, or the simpler and more tolerant constant mark run-length scheme for somewhat lower densities. It is possible that, due to the lowered power control requirements, the latter scheme may allow much smaller copy windows so that similar densities can be achieved as with the first scheme.

It is to be noted that the present invention can be applied to any reading system for domain expansion magneto-optical disk storage systems. Any waveform characteristic of the read-out signal, which indicates a change in the read-out signal, can be used in the analysis. The function of the timing circuit 34 may be provided by a discrete hardware unit or by a corresponding control program controlling a more general processing unit. The preferred embodiments may thus vary within the scope of the attached claims.

1. A method for reading a magneto-optical recording medium (10), said recording medium comprising a storage layer and a read-out layer, wherein an expanded domain leading to a reading pulse is generated in said read-out layer by copying a mark region from said storage layer to said read-out layer upon heating by a radiation power and with the aid of an external magnetic field, said method comprising the steps of
deriving a switching time of said external magnetic field from said reading pulse, and
setting the switching period of said external magnetic field to a value larger than the channel bit length of said storage layer.

2. A method according to claim 1, wherein said switching period is set to a value corresponding to the sum of a maximum allowed copy window length and said channel bit length.

3. A method according to claim 2, wherein said switching period is set to a value corresponding to three times said channel bit length.

4. A method according to claim 1, also comprising a determination step for determining a space run-length by measuring a time delay between said switching time and said reading pulse.

5. A method according to claim 4, wherein space increments smaller than a channel bit length are detected in said determination step.

6. A method according to claim 1, wherein a pulse correction is performed in a mark run-length detection based on said reading pulse.

7. A method according to claim 1, wherein read-out information is obtained only from space run-lengths.

8. An apparatus for reading from a magneto-optical recording medium (10), said recording medium comprising a storage layer and a read-out layer, wherein an expanded domain leading to a reading pulse is generated in said read-out layer by copying a mark region from said storage layer to said read-out layer upon heating by a radiation power and with the aid of an external magnetic field, said apparatus comprising:
deriving means (34, 20) for deriving a switching time of said external magnetic field from said reading pulse, and
setting means (34) for setting the switching period of said external magnetic field to a value larger than the channel bit length of said storage layer.

9. An apparatus according to claim 8, wherein said setting means (34, 20) is arranged to set said switching period to a value corresponding to the sum of the maximum allowed copy window length and said channel bit length.

10. An apparatus according to claim 9, wherein said setting means (34, 20) is arranged to set said switching period to a value corresponding to three times said channel bit length.

11. An apparatus according to claim 8, also comprising determination means (34) for determining a space run-length by measuring a time delay between said switching time and said reading pulse.

12. An apparatus according to claim 11, wherein said determination means (34) comprises a timer means for counting said time delay.

13. An apparatus according to claim 8, said apparatus being a disk player for MAMMOS disks.

14. A magneto-optical record carrier comprising a storage layer and a read-out layer, wherein an expanded domain leading to a pulse in a reading signal is generated in said read-out layer by copying a mark region from said storage layer to said read-out layer upon radiation heating and with the aid of an external magnetic field, said record carrier (10) comprising mark regions of a substantially constant length and space regions of varying lengths, wherein information is stored only in said space regions.

15. A record carrier according to claim 14, said record carrier being a MAMMOS disk (10).
